(19) United States
(12) Patent Application Publication
(10) Pub. No.: US 2005/0126993 A1
(43) Pub. Date: Jun. 16, 2005

(54) Aerator alarm unit

(76) Inventors: George E. Johnson, Downsville, LA (US); Hubbard H. Donald, Downsville, LA (US)

Correspondence Address: Clinton R. Stuart, P.O. Box 4412, Baton Rouge, LA, 70821-4412, US

(21) Appl. No.: 10/993,238

(22) Filed: Nov. 19, 2004

Related U.S. Application Data
(60) Provisional application No. 60/524,223, filed on Nov. 21, 2003.

(51) Int. Cl. C02F 3/02

(52) U.S. Cl. 210/614; 210/620; 210/90

(57) ABSTRACT

The Aerator Alarm Unit (“AAU”) is a device which simultaneously aerates the aerobic tank of a sewage treatment device, while monitoring the performance of both the sewage treatment device and the aerator. The AAU is an improvement over standard aeration devices, comprising an aerator, sensor elements, and alarm elements. The aerator provides pressurized air to the sewage treatment device, facilitating the growth of aerobic microorganisms which break down sewage. The sensor elements monitor the air pressure between the aerator and the sewage treatment device, and activate the alarm elements whenever the air pressure rises above or drops below the normal range. In this way, the AAU warns the user if the sewage treatment device is malfunctioning, and also protects the aerator from being damaged. The AAU allows for easier access for installation, maintenance, and testing, and its compact, external location improves durability and reliability.

### BACKGROUND OF THE INVENTION

This invention relates generally to aeration of sewage. More particularly, this invention relates to the treatment of sewage discharged from houses and other buildings which are not connected to a municipal sewer system, in which aerobic microorganisms within a stand-alone sewage treatment device are stimulated to process the sewage so that it is cleaned to a level acceptable for discharge into the environment. The present invention of the Aerator Alarm Unit (“AAU”) ensures effective aeration of the sewage, so that the aerobic microorganisms have the necessary elements for sewage treatment. Thus, the Aerator Alarm Unit, working in conjunction with a sewage treatment tank, provides an effective means for disposing of sewage produced by buildings outside of a local municipal sewer system.

There are several versions of conventional sewage treatment tanks which use aerobic microorganisms to break down sewage. One such device is seen in U.S. Pat. No. 5,549,818. This conventional sewage treatment device consists of a cylindrical tank which encompasses a funnel-shaped clarifier. The clarifier divides the cylindrical tank into an outer chamber, between the outer wall of the tank and the clarifier, and an inner chamber, inside the clarifier. Air is introduced into the outer chamber by multiple air droplines, which are connected to an air compressor and which pump air bubbles into the sewage in the outer chamber. Sewage flows into the outer chamber where it comes in contact with the air bubbles. The introduction of air facilitates the breakdown and digestion of the sewage by aerobic microorganisms present in the sewage. The aerated sewage then proceeds into the clarifier through an opening at the bottom of the funnel-shaped clarifier. Inside the clarifier is a quiescent zone. This area of calm in the inner chamber of the device allows for settling to occur, with the solids falling back out of the clarifier and collecting on the bottom of the treatment tank. Accordingly, the waste water becomes cleaner as it progresses upward in the funnel-shaped clarifier, continuing to allow gravity to separate the solids from the water. So, by the time the sewage has progressed up through the clarifier, it has been substantially cleaned. This treated effluent exits near the top of the clarifier and is discharged. This aerobic clarification process has also been combined with additional cleaning stages, such as in an earlier invention by the present inventors set forth in U.S. Pat. No. 6,228,258.

Alternatively, multi-tank aerobic sewage treatment devices which do not employ a clarifier also exist. For example, a diffusion bar aerobic treatment plant was earlier described by the present inventors in patent application Ser. No. 10/222,600. These prior patents by the present inventors are fully incorporated herein, as they provide additional details concerning the types of aerobic sewage treatment devices with which the present invention may be used. Obviously, these descriptions are merely illustrative, and do not limit the scope of the Aerator Alarm Unit described herein. The Aerator Alarm Unit is fully functional with any aerobic sewage treatment device.

While current aerobic sewage treatment devices employ some sort of aeration unit, they do not include an incorporated monitor which ensures that the aerator is functioning properly. It is critically important that the aerator unit on an aerobic sewage treatment device operate properly, since the device depends on the action of aerobic microorganisms to break-down the sewage. Aerobic microorganisms cannot perform this work unless the oxygen/air level within the sewage is maintained at the appropriate level. More specifically, if the oxygen/air level in the sewage drops too low, then the aerobic microorganisms will begin to die, and there will not be a sufficient number of microorganisms to effectively process the sewage flowing through the device. Another possible aerator problem would be any sort of condition that might cause damage to the physical mechanism of the aerator, since this could cause a complete loss of oxygen/air flow to the aerobic microorganisms (since this would, again, result in the inability of the aerobic sewage treatment device to process sewage effectively). The AAU is superior to existing aeration means because it incorporates sensing and alarm elements in conjunction with the aerator, to ensure both 1) that the sewage treatment device receives adequate aeration for effective sewage treatment and 2) that the aerator does not experience conditions that might damage its operating mechanisms. By monitoring the pressure between the aerator and the sewage treatment device, the AAU can effectively warn the user/owner of a problem concerning either the sewage treatment device or the aerator.

Currently available sensor arrangements do not accomplish these two related goals. Instead, the currently available sensors focus on detecting high-water within the sewage treatment device. The standard current industry arrangement for detection of a high water condition is to use a mercury encapsulated switch inside of a floating vessel or a mechanical weight—operated switch inside of a floating vessel to detect the high water condition. The vessel with the switch inside will rise with the level of the water and will eventually close the mercury switch, causing an electrical path back to an alarm circuit. So, while these sensors can detect a sewage overflow situation, they do not monitor to ensure effective aeration within the sewage treatment device, and they do not actually monitor the backpressure to the aerator to protect against damage to the aerator from excessively high pressure.

The present invention of the Aerator Alarm Unit is superior to existing technology because it uses a single device to monitor both the aerator and the sewage treatment device. The AAU incorporates a sensor-alarm panel with an aerator unit (which uses a compressor to pump air into the sewage treatment device), replacing and upgrading the separate and distinct (as well as more limited) sensor technology currently available with an integrated and compact unit. The sensor-alarm panel typically includes both a high and low pressure sensor, and one or more alarm elements. The alarm elements can be, for example, audible and/or visual, with an audible sound alarm and/or a visual light signal activated if the sensor panel monitors a potentially problematic situation. Typically, the sensor-alarm panel is set up to monitor for high pressure, while also monitoring for low (or even no) pressure. Thus, the alarm will activate whenever the air pressure in the air supply tube between the aerator and the aerobic tank of the sewage treatment device falls below or rises above normal operating pressures. This ensures that the aerator provides an adequate air supply to the aerobic sewage treatment device (while also ensuring that the aerator will not be damaged due to excessively high pressure buildups), by continuously monitoring the air pressures and activating an alarm to notify the owner/operator should a potential problem be detected.

The AAU has many advantages over the currently available sensors. First, the AAU senses for a low pressure situation, to ensure that the aerator is providing sufficient aeration to the sewage treatment device, while simultaneously sensing for a high pressure situation, to ensure that the aerator mechanism will not be damaged. The high pressure sensor may also act to alert the user/owner in the event of a high water situation. Thus, the AAU simultaneously monitors both the aerator and the sewage treatment device. In the AAU, the sensor mechanisms are all located outside of the sewage treatment device, increasing the reliability and lifespan of the sensors (since they are not exposed to the unfavorable environmental conditions inside the tank and may be maintained and repaired more easily). This is another significant improvement over current sensor technology. Finally, the compact nature of the AAU is an improvement, since it simplifies installation and reduces the chances of problems in linking components. So in a multitude of ways, the AAU is superior to the current state of the art.

### SUMMARY OF THE INVENTION

The Aerator Alarm Unit (“AAU”) is a device which comprises an aerator (for pumping air/oxygen into the aerobic sewage treatment device), as well as a sensor-alarm panel. These two elements are most typically designed to operate independently, so that the aerator will continue to pump air/oxygen to the sewage treatment device regardless of whether or not the sensor alarm panel has monitored conditions outside of the normal operating range (although in an alternative embodiment, the aerator could connect to the sensor alarm panel via a kill switch, such that the aerator would be deactivated if the alarm had run for more than a pre-set amount of time without being manually deactivated). For the sake of efficiency, in the preferred embodiment both the aerator and the sensor-alarm panel would typically operate based on a single power source, and would be attached in close proximity (either within a single housing or with the sensor-alarm panel housing mounted upon the housing for the aerator).

The aerator is essentially an external air compressor unit, which acts to pump the air necessary for aerobic treatment of sewage in an aerobic sewage treatment device. The sensor alarm panel includes sensor elements and alarm elements. The sensor elements are designed to monitor operating conditions, and to activate the alarm elements in the event that conditions outside of the normal operating conditions are detected. In the preferred embodiment, the sensor elements monitor high and low air pressure. Thus, the alarm elements would be activated whenever the air pressure from the aerator to the sewage treatment device falls below or rises above normal operating conditions.

For example, if the sensor elements detect that the aerator is failing to maintain pressure (which might indicate a break in the supply line or a mechanical failure concerning the aerator, causing low pressure), then the alarm elements would activate. Or if the sensor elements detect that there is high pressure (which could be caused, for example by high water in the sewage treatment device blocking the inlet and/or outlet pipes into the aerobic tank of the sewage treatment device, or by blockage of the diffuser/air supply line), then the alarm elements would activate. In this way, the alarm warns the user if the sewage treatment device needs immediate attention in order to (1) function properly so that clean sewage is discharged (preventing pollution/contamination due to inadequate aerobic treatment of sewage) or (2) prevent damage to the aerator powering the aerobic sewage treatment device (so that the aerobic sewage treatment device continues to operate over time and will not malfunction, and so that the aerator's life is extended).

An optional element available on the preferred embodiment is a switch which allows the Aerator alarm Unit to be set for different modes. The first switch setting places the Aerator Alarm Unit in test mode. Test mode activates the alarm(s), enabling the user to ensure that the alarms are functioning properly. The second switch setting places the Aerator Alarm Unit in run mode. This is the normal operation mode for the AAU (in which it monitors the pressures and activates the alarm if necessary). The third switch setting places the Aerator Alarm Unit in mute mode. This mode disconnects the audio alarm, so that the AAU runs as normal but will only activate the remaining alarm elements (for example, visual alarm elements). In the preferred embodiment, the alarm elements include both an audible alarm and a visual alarm. So, for example, in mute mode, the Aerator Alarm Unit would activate only the visual alarm if the sensor elements monitor pressures outside of the normal range.

Typically, the Aerator Alarm Unit would mount atop the sewage treatment unit that it services, so that if the sewage treatment device is buried underground, the Aerator Alarm Unit would project up above the surface. Alternatively, it could be placed elsewhere at some location above ground (and connected to the sewage treatment device via an extended air supply line), while the entire sewage treatment device is buried beneath the surface of the ground. Regardless, the Aerator Alarm Unit must have some access to an open ventilation source, from which it can draw its air supply.

By using a sensor-alarm panel that operates by monitoring the aerator, several important goals may be accomplished. First, the sensor-alarm panel will typically be housed in association with the aerator itself, above ground and external to the sewage treatment device aerobic tank. This design allows for effective monitoring of the sewage treatment device's effectiveness without the need to place the sensor elements within the harsh environment of the sewage treatment device aerobic tank. By removing the sensor elements from the inside of the sewage treatment device aerobic tank and instead placing them outside the tank in conjunction with the aerator, the reliability and lifespan of the sensor elements is increased because there is less chance of 1) environmental erosion affecting the sensor elements and/or 2) damage or deterioration to the wiring between the sensor elements and the alarm. Furthermore, the sensor-alarm panel and aerator of the present invention function in a cooperative manner, since this design improves the lifespan of the aerator while also allowing the sensor-alarm panel to directly monitor the performance of the critical aerator element as well as the overall functioning of the sewage treatment device. In other words, this integrated design provides additional monitoring capability.

Placing the sensor elements outside of the aerobic tank of the sewage treatment device in association with the aerator also simplifies periodic maintenance and testing of the alarm elements. Since the alarm elements in the present invention are located above ground, ease-of-access is greatly improved. Finally, it is much easier to retrofit existing sewage treatment devices to add in sensing/alarm capabilities using this unit (rather than using float switch technology or other such means), since the sewage treatment device itself does not have to be opened up and altered internally. Instead, the standard aerator for existing aerobic sewage treatment devices can simply be replaced with an entirely new Aerator Alarm Unit, or a sensor-alarm panel could even be connected to the existing standard aerator in a retrofit. Regardless of retrofit technique, it would be relatively straightforward to use prepackaged equipment in order to improve an existing aerobic sewage treatment device in the manner set forth herein by the applicants by adding an external monitor and alarm in connection to the aerator.

When the Aerator Alarm Unit is installed for use with an aerobic sewage treatment device, the AAU pumps air into the aerobic tank of the sewage treatment device via an air feed tube. The air feed tube distributes air to whatever mechanism is in place within the aerobic tank of the sewage treatment tank (such as a diffuser or air droplines), so that air will be emitted out into the aerobic tank, aerating the sewage. Injecting air into the sewage activates and stimulates the aerobic microorganisms in the sewage, which causes the aerobic microorganisms to multiply and increases the amount of sewage that they digest. This aerobic process eliminates sewage contaminants to a great extent, cleaning the sewage.

As the aerator of the AAU operates, the sensor-alarm panel monitors the air pressure in the tube between the aerator and the sewage treatment tank. In normal run mode, the AAU will pump air continuously down into the sewage treatment tank. If the sensor alarm panel monitors a problem (either high or low pressure outside of the normal operating range), then the alarm elements will be activated to notify the owner/user of a potential problem so that they can check the situation and call for repair service if necessary. In this manner, the AAU keeps the aerobic sewage treatment device operating effectively (by ensuring that it has the appropriate amount of air necessary for aerobic sewage treatment) and improves the operable lifespan of the aerator (by allowing quick maintenance to keep the proper conditions for durable aerator operation).

It is an object of the present invention to aerate sewage in preparation for discharge. In doing so, this invention operates in conjunction with an aerobic sewage treatment device in order to facilitate aerobic microorganisms breaking down sewage. It is another object of this invention to monitor the air pressure between the aerator and the sewage treatment device. It is yet another object of this invention to monitor for high and low pressure. It is still another object of this invention to notify the user/owner whenever it senses conditions outside of the normal operating range. It is still another object of this invention to employ both audible and visual alarm elements for notifying the user/owner. It is still another object of this invention to be easy to install. It is still another object of this invention for it to simplify periodic maintenance and testing, and to provide an easy method of retrofitting existing aerobic sewage treatment devices. It is still another object of this invention to provide a test mode, allowing the user/owner to test the functioning of the alarm elements.

It is yet another object of this invention to locate the aerator, sensor elements, and alarm elements above ground and external to the sewage treatment device. It is yet another object of this invention to increase the lifespan of the aerator. It is yet another object of the present invention to improve the effectiveness/efficiency of an aerobic sewage treatment tank. It is still another object of this invention to prevent damage to the aerator of a sewage treatment device. It is still another object of this invention to provide aeration capabilities and sensor-alarm capabilities in a single, compact unit. It is still another object of this invention to be used in conjunction with existing aerobic sewage treatment devices to produce discharge water which meets or exceeds national (as well as state or local) water quality requirements. These and other objects will be apparent to those skilled in the art field.

### BRIEF DESCRIPTION OF DRAWINGS

Reference will be made to the drawings where like parts are designated by like numerals and wherein:

FIG. 1 is a cut-away side view, showing the AAU located atop a sewage treatment device;

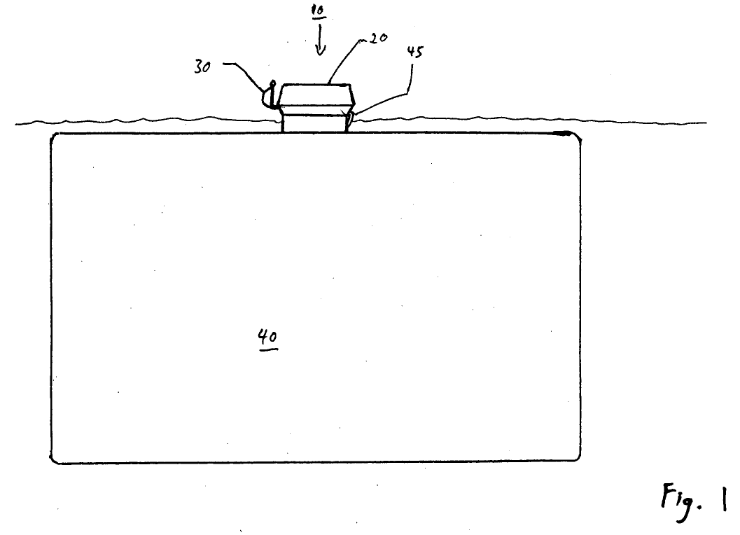

FIG. 2 is a cut-away side view, showing the AAU connected to a sewage treatment device via an extended air supply line;

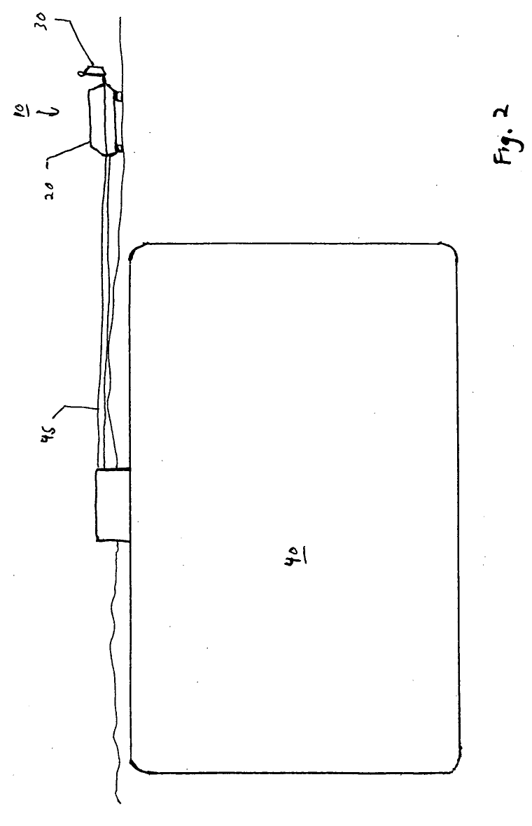

FIG. 3 is a side view of the AAU, showing the sensor-alarm panel attached to the aerator via a bracket;

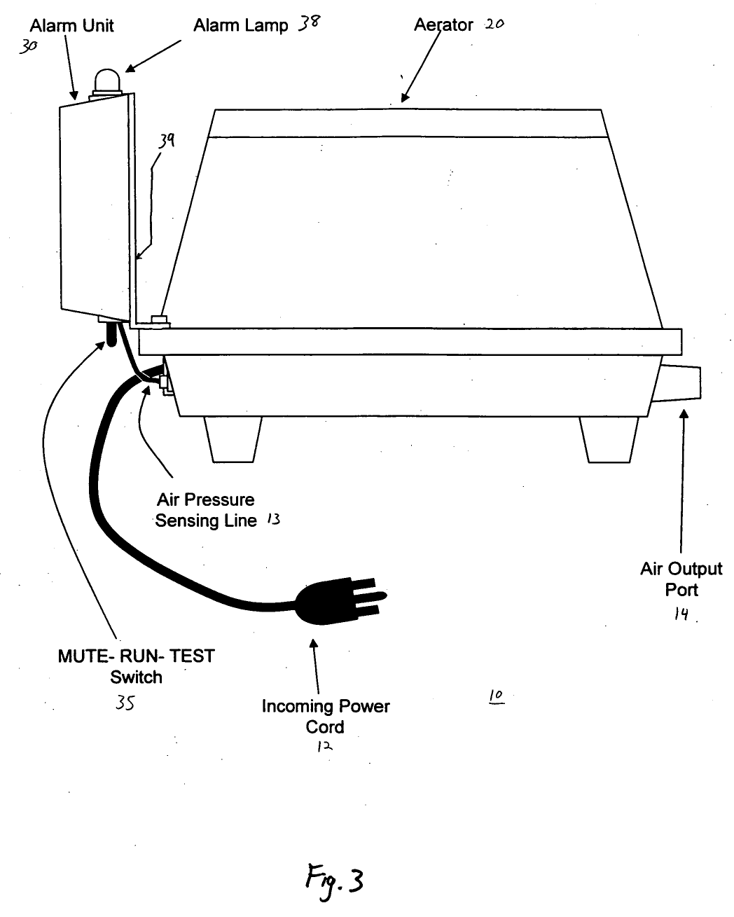

FIG. 4 is a top view of the AAU;

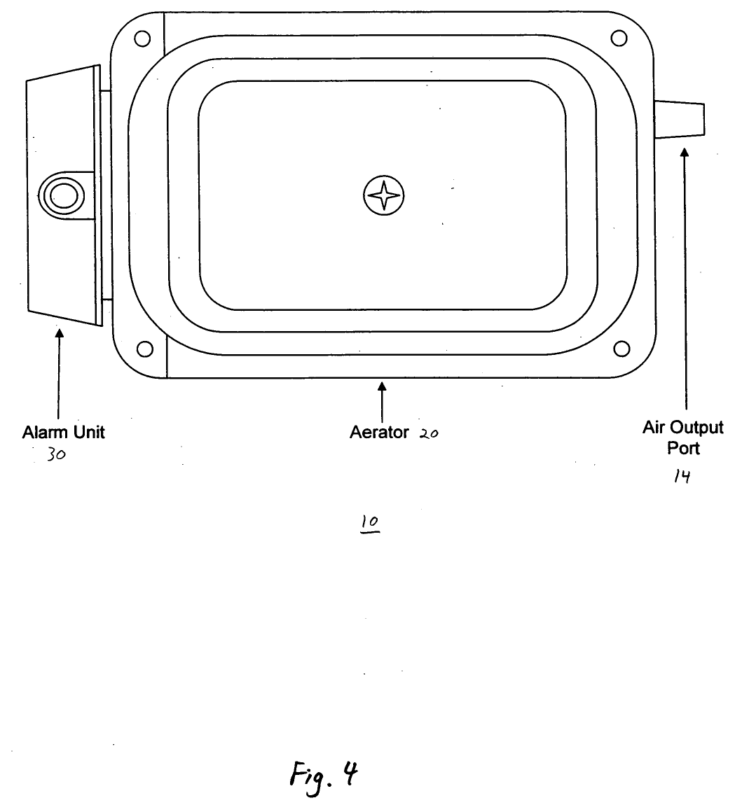

FIG. 5 is a front view of the AAU; and

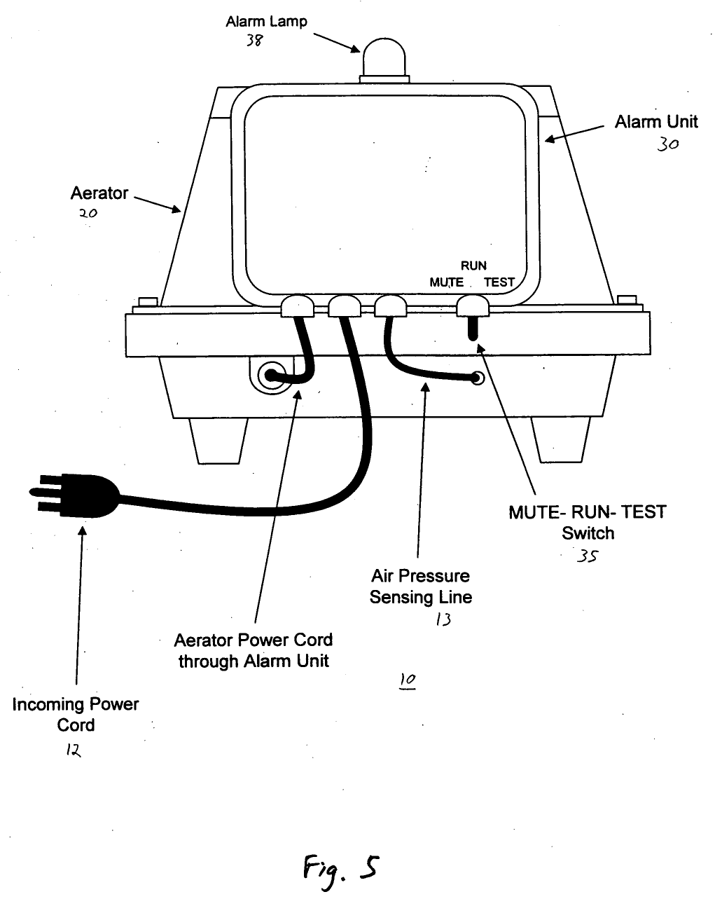

FIG. 6 is a schematic diagram of the electrical circuit of the preferred embodiment of the AAU, demonstrating the interconnected electrical nature of the sensor-alarm panel and the aerator.

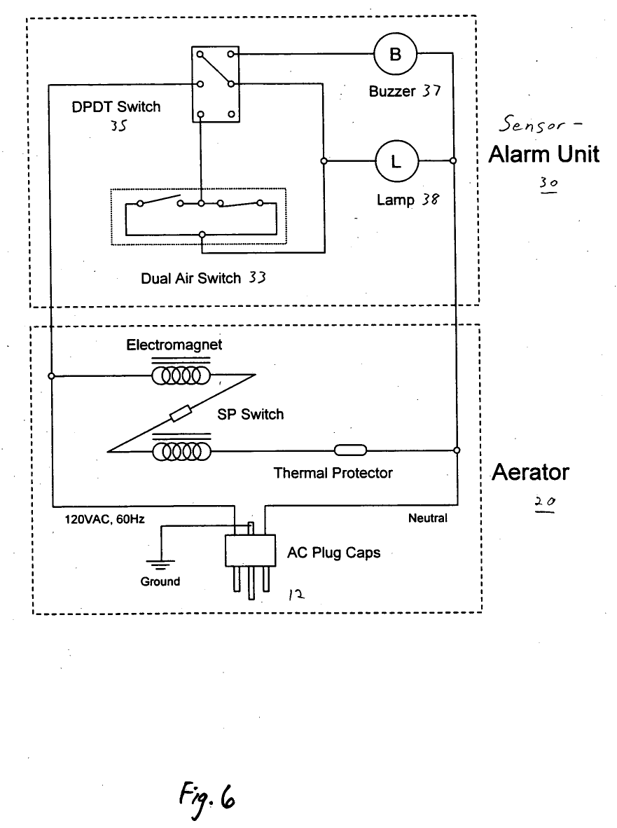

### DETAILED DESCRIPTION OF PREFERRED EMBODIMENT

The Aerator Alarm Unit (“AAU”) 10 is a device which comprises an aerator 20 (for pumping air/oxygen into the aerobic sewage treatment device 40), as well as a sensor-alarm panel 30. These two elements are most typically designed to operate independently, so that the aerator 20 will continue to pump air/oxygen to the sewage treatment device 40 regardless of whether or not the sensor alarm panel 30 has monitored conditions outside of the normal operating range (although in an alternative embodiment, the aerator 20 could connect to the sensor alarm panel 30 via a kill switch, such that the aerator 20 would be deactivated if the alarm had run for more than a pre-set amount of time without being manually deactivated). However, for the sake of efficiency, in the preferred embodiment both the aerator 20 and the sensor-alarm panel 30 would typically operate based on a single power source, and would be attached in close proximity (either within a single housing or with the sensor-alarm panel 30 housing mounted upon the housing for the aerator 20).

The aerator 20 is essentially an external air compressor unit, which acts to pump the air necessary for aerobic treatment of sewage in a sewage treatment device 40. In the preferred embodiment, for example, the aerator 20 functions as set out by NSF/ANSI 40 standard for aerobic treatment units. The sensor alarm panel 30 includes sensor elements and alarm elements. The sensor elements are designed to monitor operating conditions, and to activate the alarm elements in the event that conditions outside of the normal operating conditions are detected. In the preferred embodiment, the sensor elements monitor high and low air pressure. Thus, the alarm elements would be activated whenever the air pressure from the aerator 20 to the sewage treatment device 40 falls below or rises above normal operating pressure conditions.

For example, if the sensor elements detect that the aerator 20 is failing to maintain pressure (which might indicate a break in the supply line or a mechanical failure concerning the aerator 20, causing low pressure), then the alarm elements would activate. Or if the sensor elements detect that there is high pressure (which could be caused, for example by high water in the sewage treatment device 40 blocking the inlet and/or outlet pipes into the aerobic tank of the sewage treatment device 40, or by blockage of the diffuser and/or air supply line), then the alarm elements would activate. In this way, the sensor-alarm panel 30 warns the user if the sewage treatment device needs immediate attention in order to (1) function properly so that clean sewage is discharged (preventing pollution/contamination due to inadequate aerobic treatment of sewage) or (2) prevent damage to the aerator 20 powering the aerobic sewage treatment device 40 (so that the aerobic sewage treatment device 40 continues to operate over time and will not malfunction, and so that the aerator's life is extended).

Normal operating conditions will vary depending upon the needs of the particular aerobic sewage treatment device 40 at issue. Obviously, the low end of the normal operating condition range should be set based on the minimum sufficient air pressure that must be provided to the aerobic sewage treatment device 40 in order to effectively aerate the sewage (so that the aerobic microorganisms will have sufficient air to break down the sewage). Persons skilled in the art field will understand and be able to determine this minimum pressure level for a particular sewage treatment device 40. In fact, the particular sewage treatment device 40 at issue typically defines this pressure level within its instruction materials. Factors which might affect the appropriate minimum pressure level would include the size/volume of the tank to be aerated, column inches of water pressure, the depth of the aerobic tank, the sewage flow rate through the aeration tank (i.e. the amount of time that the sewage spends in the tank), and the size of the air discharge holes in the diffuser or air droptubes (since the air pressure must be sufficiently high to keep water out of the discharge holes, so that water cannot enter the air supply line 45).

The high end of the normal operating condition pressure range could be set based on the lower of two factors: 1) the back-pressure exerted whenever the sewage in the aeration tank of the sewage treatment device 40 is in an overflow condition, or 2) the back-pressure level (due to blockage, etc.) which will result in structural damage to the aerator 20 itself (which likely would be set forth in the instructions included with the aerator 20). Obviously, the back-pressure for an overflow situation need not be used, if the main concern is merely protecting the aerator 20 from damage; by taking this overflow back-pressure into account, however, the high pressure level sensor further monitors the condition of the sewage treatment device 40. Accordingly, the actual normal operating range for the AAU 10 must be set at the time it is connected to the sewage treatment device 40 it will service (unless, of course, the particular AAU 10 is specifically designed for use with a particular sewage treatment unit 40).

Typically, then, the normal operating range for the preferred embodiment would be infinitely adjustable, so that the high and low pressure levels (for the normal operating condition range) could be set anywhere between 0-5 pounds per square inch (above atmospheric pressure; i.e. positive pressure). Clearly, this range for the preferred embodiment is not limiting, and could vary depending on the needs of the particular sewage treatment device 40 being serviced. The preferred embodiment of the AAU 10 has its preferred normal operating range listed based on the pressures of typical aerobic sewage treatment devices employed and sold by the inventors; it is possible that the normal operating pressure condition range could extend to include other pressures than set forth for the preferred embodiment (depending upon the needs of the sewage treatment device 40).

The preferred embodiment of the AAU 10 employs a dual air switch type of sensor-alarm panel 30. The alarm elements of this configuration will be activated when the air pressure created by the aerator 20 falls below or rises above the normal operating pressures. The dual air switch type sensor-alarm panel 30 would be activated (based on a low pressure situation), for instance, if the aerator 20 failed to maintain the minimum operating pressure due to some sort of mechanical failure within the aerator 20, or if there was a break in the air supply line 45 (creating a leak). The alarm would also be activated (based on a high pressure situation) during a high water condition in which the inlet and outlet pipes within the aerobic tank of the sewage treatment device 40 are being blocked by an over fill of water in the tank. This would cause the pressure in the tank to rise significantly above normal operating limits. A high pressure condition could also exist if there were a blockage of the diffuser element within the aerobic tank of the sewage treatment device 40 (i.e. the element for dispersing air into the sewage) or the air supply line 45 leading from the aerator 20 to the sewage treatment device 40. The alarm condition will remain activated until pressure returns to within the normal operating pressure range. This high pressure detection feature of the sensor-alarm panel 30 could significantly increase the life of the aerator 20, since the aerator life is shortened when a maintained back pressure is applied to the aerator 20 for a prolonged period of time.

In the preferred embodiment, the actual sensing element used to monitor for high and low pressure outside the normal operating condition range is a dual air switch 33. The dual air pressure switch 33 has two rubberized diaphragms encased into a single housing. The air pressure from the aerator 20 inputs between the two diaphragms. Against the outside of each of the diaphragms are two micro-switches. One micro-switch is arranged in the normally open position, and the other is arranged in the normally closed position. When the air pressure increases to the normal operating range, the normally closed switch is opened so that electrical current will not flow to the alarm circuit. This circuit monitors the low air pressure side of the switch. If the air pressure falls below the normal operating range, the micro-switch will close causing an electrical path back to an alarm circuit. If the air pressure increases to outside the normal operating range, the normally open micro-switch will close providing an electrical path back to the alarm circuit. This circuit monitors the high air pressure side of the switch. While this sort of dual air pressure switch 33 performs the high and low pressure monitoring in the preferred embodiment, obviously other sensor arrangements are possible.

For example, a second sensor arrangement could incorporate two separate single air pressure switches, each of which is set to a different pressure setting. One switch would be set to open at a low pressure setting, and the other would be set to close at a high pressure setting. The two switches could then be joined together by means of air tubing and an air tubing tee, which would feed both air switches simultaneously and, in effect, give the same result as the dual air switch 33 explained above. Any sensor arrangement which converts the physical air pressure information into electrical inputs that affect whether or not the sensor-alarm panel 30 circuit activates alarm elements would likewise operate. Persons skilled in the art field will comprehend alternative sensors and sensor arrangements, all of which are included within the scope of this invention.

In the preferred embodiment, the audible alarm is buzzer 37 that sounds as a warning, and the visual alarm is a lamp 38 that illuminates to notify the user/owner of a potential problem. Clearly any number of other types of audible and visual devices might serve as alarm/warning/notification elements. The sensor-alarm panel 30 circuit simply activates the alarm elements in the event that non-normal operating conditions are detected, and the alarm elements then warn the user/owner according to their design/function. By way of example, the audible alarm could alternatively be a bell, a horn, a whistle, activation of an electronic speaker device (such that it emits a sound), or an automated telephone call. Examples of alternative visual alarms could include a flashing LCD light, activation of an electronic monitor with a warning message, transmission of an e-mail message, or transmission of a printed warning message to a designated site (akin to telex or facsimile).

In the preferred embodiment, the sensor-alarm panel 30 is housed within a separate case, which is typically mounted to the case of the aerator unit 20. In the preferred embodiment, the sensor-alarm panel 30 housing is rigidly attached to the housing of the aerator 20 via a bracket 39. And in the preferred embodiment, a single power source operates both the aerator 20 and the sensor-alarm panel 30. While any electrical power source may operate the AAU 10, the preferred power source is AC current from a standard electrical socket. Thus, in the preferred embodiment, the power cord 12 for the aerator 20 is also connected to power the sensor-alarm panel 30. The power cord 12 connects the aerator 20 and the sensor-alarm panel 30 in parallel, to operate both elements of the AAU 10 off the same power source.

The preferred embodiment further makes use of an air sensing port in the aerator 20, which is attached to the sensor-alarm panel 30 via an air pressure sensing line/tube 13. It is through this connection that the air pressure at the bottom of the aerator 20 (i.e. the pressure in the air output port 14, which connects via the air supply line 45 to the sewage treatment device 40) is monitored by the dual air switch 33 of the sensor-alarm panel 30. In other words, the air pressure sensing line 13 provides the relevant air pressure to the sensor-alarm panel 30, in order to determine whether or not the air pressure is within the normal operating range.

An optional element available on the preferred embodiment is a switch 35 which allows the Aerator Alarm Unit 10 to be set for up to three different modes. In essence, the different modes are built into the circuitry of the sensor-alarm panel 30 as an electrical switch. The first switch setting places the Aerator Alarm Unit 10 in test mode. Test mode activates the alarm(s), enabling the user to ensure that the alarms are functioning properly. So in test mode, voltage is applied to the alarm elements of the circuit, to ensure that the circuitry and the physical elements of the alarm elements are operating properly. The second switch setting places the Aerator Alarm Unit 10 in run mode. This is the normal operation mode for the AAU 10 (in which it monitors the pressures and activates the alarm if necessary). In essence, this is the static state of the sensor-alarm circuitry, allowing normal operation.

The third switch setting places the Aerator Alarm Unit 10 in mute mode. This mode disconnects the audio alarm, so that the AAU 10 runs as normal but will only activate the remaining alarm elements (for example, visual alarm elements). Basically, the portion of the circuit controlling the audible alarm element becomes electrically disconnected, so that it does not actively interact with the remainder of the sensor-alarm panel 30. In the preferred embodiment, the alarm elements include both an audible alarm and a visual alarm. So for example, in mute mode, the Aerator Alarm Unit 10 would activate only the visual alarm if the sensor elements monitor pressures outside of the normal range. The alarm elements in the preferred embodiment give an audible and/or visible warning, as set out in the NSF/ANSI 40 standard for system failure indications. Of course, additional, optional modes (such as an “off” mode) could also be incorporated into the circuitry of the sensor-alarm panel 30.

Typically, the Aerator Alarm Unit 10 would mount atop the sewage treatment device 40 that it services, so that if the sewage treatment device 40 is buried underground, the AAU 10 would project up above the surface. Alternatively, it could be placed elsewhere at some location above ground (and connected to the sewage treatment device 40 via an air supply line 45), while the entire sewage treatment device 40 is buried beneath the surface of the ground. Regardless, the Aerator Alarm Unit 10 must have some access to an open ventilation source, from which the aerator 20 can draw its air supply.

By using a sensor-alarm panel 30 that operates by monitoring the aerator 20, several important goals may be accomplished. First, the sensor-alarm panel 30 will typically be housed in association with the aerator 20 itself, above ground and external to the sewage treatment device 40 aerobic tank. This design allows for effective monitoring of the sewage treatment device's effectiveness without the need to place the sensor elements within the harsh environment of the sewage treatment device 40 aerobic tank. By removing the sensor elements from the inside of the sewage treatment device 40 aerobic tank and instead placing them outside the tank in conjunction with the aerator 20, the reliability and lifespan of the sensor elements is increased because there is less chance of environmental erosion effecting the sensor elements and/or damage or deterioration to the wiring between the sensor elements and the alarm.

Furthermore, the sensor-alarm panel 30 and aerator 20 of the present invention function in a cooperative/synergistic manner, since this design improves the lifespan of the aerator 20 while also allowing the sensor-alarm panel 30 to directly monitor the performance of the critical aerator 20 element as well as the overall functioning of the sewage treatment device 40. In other words, this integrated design provides additional monitoring capabilities, which would not be available if the sensor elements were located within the sewage treatment device 40 itself.

Placing the sensor elements in conjunction with the aerator 20 (outside of the aerobic tank of the sewage treatment device 40) also simplifies periodic maintenance and testing of the alarm elements. Since the alarm elements in the present invention are located above ground, ease-of-access is greatly improved. Finally, it is much easier to retrofit existing sewage treatment devices 40 to add in sensing/alarm capabilities using this unit (rather than using float switch technology or other such means), since the sewage treatment device 40 itself does not have to be opened up and altered internally. Instead, the standard aerator 20 for existing aerobic sewage treatment devices 40 can simply be replaced with an entirely new Aerator Alarm Unit 10, or a sensor-alarm panel 30 could even be connected to the existing standard aerator 20 in a retrofit. Regardless of retrofit technique, it would be a relatively simple matter to use prepackaged equipment provided by the applicants to improve an existing aerobic sewage treatment device 40 by adding an external monitor and alarm in connection to the aerator 20.

When the Aerator Alarm Unit 10 is installed for use with an aerobic sewage treatment device 40, the AAU 10 pumps air into the aerobic tank of the sewage treatment device 40 via an air supply line 45. The air supply line 45 distributes air to whatever mechanism is in place within the aerobic tank of the sewage treatment tank 40, so that air will be emitted out into the aerobic tank, aerating the sewage. Injecting air into the sewage activates and stimulates the aerobic microorganisms in the sewage, which causes the aerobic microorganisms to multiply and increases the amount of sewage that they digest. This aerobic process eliminates sewage contaminants to a great extent, cleaning the sewage.

As the aerator 20 of the AAU 10 operates, the sensor-alarm panel 30 monitors the air pressure in the air supply line 45 between the aerator 20 and the sewage treatment tank 40. Specifically, in the preferred embodiment the dual air switch 33 monitors the air pressure in the air supply line 45 leading from the aerator air output port 14 to the sewage treatment device 40 via the air pressure sensing line 13. In normal run mode, the AAU 10 will pump air continuously down into the sewage treatment tank 40. If the sensor-alarm panel 30 monitors a problem (either high or low pressure outside of the normal operating range), then the alarm elements will be activated to notify the owner/user of a potential problem so that they can check the situation and call for repair service if necessary.

In the preferred embodiment, both an audible alarm and a visible alarm would be activated in normal run mode. In mute mode, however, only the visible alarm would be activated. In this manner, the AAU 10 keeps the aerobic sewage treatment device 40 operating effectively (by ensuring that it has the appropriate amount of air necessary for aerobic sewage treatment) and improves the operable lifespan of the aerator 20 (by allowing quick maintenance to keep the proper conditions for durable aerator 20 operation). In the preferred embodiment, the user/owner may also test the alarm elements (to ensure that they are still functioning properly and will be able to effectively notify/warn the user/owner of a potential problem) using the test mode feature of the AAU 10. Another option would be to configure the sensor-alarm panel 30 so that different alarms would be activated to notify the user/owner of high and low pressure conditions.

In the preferred embodiment, the aerator 20 and the sensor-alarm panel 30 operate independently, so that the aerator 20 will continue to pump air to the sewage treatment device 40 regardless of whether or not the sensor alarm panel 30 has monitored conditions outside of the normal operating range. This ensures that the sewage treatment device 40 has aeration for as long as possible (since aeration is key to effective sewage treatment), even at the risk of damaging the aerator 20. An alternative embodiment, would connect the aerator 20 to the sensor alarm panel 30 in conjunction with a kill switch, such that the aerator 20 would be deactivated if the alarm had run for more than a pre-set amount of time without being manually deactivated. This alternative configuration would protect the aerator 20 from being damaged, but it would have the drawback of leaving the sewage treatment device 40 more unreliable and dependent upon quick human maintenance (especially since the alarm may sound under conditions that do not signal potential damage to the aerator 20, i.e. low pressure conditions).

Additional alternatives would include a battery backup power supply for the AAU 10, which would run the device in the event that the primary power source ceased functioning (so that, for example, if electrical power goes down, the sewage treatment device 40 would continue to operate effectively for a period of time), and/or a sensor-alarm panel 30 which further includes an alarm activation routine in case of power loss (notifying the user/owner that the sewage treatment device is no longer being aerated). Obviously other optional features, such as automatic notification to a service representative via a connected phone line, could also be included.

The precise rate of air flow and air pressure which the aerator 20 should produce will depend upon the size and type of aerobic sewage treatment device 40 at issue. A person of ordinary skill in the art field will readily understand and be able to adapt the AAU 10 to provide the particular needs of a specific aerobic sewage treatment device 40. Considerations which could affect the flow rate of the aerator include the size and depth of the aerobic sewage treatment device, and the size of the discharge holes in the diffuser or air droptubes. And clearly, the aerator would need to provide sufficient air flow to effectively aerate the sewage in the aerobic tank of the sewage treatment device. In the preferred embodiment, the aerator 20 is designed so that under normal operating conditions it would provide the necessary flow of air to an aerobic sewage treatment device 40 as set forth by NSF/ANSI 40 standard for aerobic treatment units.

The specific embodiments and uses set forth herein are merely illustrative examples of the preferred embodiment of the AAU 10 invention and are not intended to limit the present invention in any way. A person skilled in the field will understand and appreciate additional embodiments and uses, as well as equivalents, which are also included within the scope of the present invention. Furthermore, any patents listed herein by way of example are specifically incorporated by reference. The scope of the invention is more fully defined in the following claims, and the only limits to the scope of the invention are those set forth explicitly in the claims below.

1. A device for aerating sewage comprising:
an aeration means;
a sensing means; and
a notification means;
wherein said sensing means monitors for events outside normal operating conditions; and
said sensing means activates said notification means whenever non-normal conditions are detected.

2. A device as in claim 1 wherein said sensing means detects air pressure.

3. A device as in claim 2 wherein said sensing means monitors for air pressure conditions outside normal operating conditions.

4. A device as in claim 3 wherein said sensing means activates said notification means whenever air pressure from said aeration means is detected above or below normal operating conditions.

5. A device as in claim 1 further comprising a sewage treatment device, wherein said sensing means is located outside of said sewage treatment device.

6. A device as in claim 3 further comprising a sewage treatment device, wherein said sensing means is located outside of said sewage treatment device.

7. A device as in claim 6 wherein said sensing means activates said notification means whenever air pressure from said aeration means is detected above or below normal operating conditions.

8. A device as in claim 7 further comprising a switch, wherein:
said aeration means further comprises an aerator;
said notification means further comprises alarm elements; and
said switch connects to said alarm elements.

9. A device as in claim 8 wherein said switch may activate said alarm elements and wherein said switch may mute said alarm elements.

10. A device as in claim 8 wherein said alarm elements further comprise a visual alarm and an audible alarm.

11. A device as in claim 10 wherein said switch may activate said alarm elements and wherein said switch may mute said alarm elements.

12. A device as in claim 6, wherein:
said aeration means aerates said sewage treatment device;
said sensing means monitors air pressure between said aeration means and said sewage treatment device; and
said sensing means activates said notification means whenever air pressure is detected above or below normal operating conditions.

13. A device as in claim 8, wherein:
said aerator aerates said sewage treatment device;
said sensing means monitors air pressure between said aerator and said sewage treatment device; and
said sensing means activates said alarm elements whenever air pressure is detected above or below normal operating conditions.

14. A device as in claim 13 wherein said switch may activate said alarm elements and wherein said switch may mute said alarm elements.

15. A device as in claim 13 wherein said alarm elements further comprise a visual alarm and an audible alarm.

16. A device as in claim 15 wherein said switch may activate said alarm elements and wherein said switch may mute said alarm elements.

17. A device for aerating a sewage treatment unit comprising:
an aerator; and
a sensor-alarm panel;
wherein said sensor-alarm panel is located outside of the sewage treatment unit.

18. A device as in claim 17 wherein said sensor-alarm panel further comprises sensor elements and alarm elements, and wherein said sensor elements monitor air pressure between said aerator and the sewage treatment unit.

19. A device as in claim 18 wherein said sensor elements activate said alarm elements whenever air pressure is detected outside normal operating conditions.

20. A device as in claim 18 wherein said sensor elements monitor high and low pressure.

21. A device as in claim 20 wherein said sensor elements activate said alarm elements whenever air pressure is detected above or below normal operating conditions.

22. A device as in claim 21 further comprising an air supply line, wherein:
said aerator transmits air to the sewage treatment unit via said air supply line; and
said sensor elements detect air pressure in said air supply line.

23. A device as in claim 22 further comprising a switch, wherein said switch connects to said alarm elements.

24. A device as in claim 23 wherein said switch may activate said alarm elements and wherein said switch may mute said alarm elements.

25. A device as in claim 22 wherein said alarm elements further comprise an audible alarm and a visual alarm.

26. A device as in claim 25 further comprising a switch, wherein said switch may activate said alarm elements and wherein said switch may mute said alarm elements.

27. A device as in claim 25 wherein said audible alarm further comprises a buzzer.

28. A device as in claim 22 wherein said sensor elements further comprise a dual air switch.

29. A device as in claim 28 wherein normal operating conditions are a range of pressures, with the low pressure level and the high pressure level both set between 0 and 5 pounds per square inch.

30. A device as in claim 22 wherein said sensor alarm panel is mounted onto said aerator.

31. A method for ensuring effective aeration of a sewage treatment device using an aerator, a sensor, and an alarm, comprising the steps of:
aerating said sewage treatment device; and
monitoring air pressure between said aerator and said sewage treatment device.

32. A method as in claim 31 further comprising the step of activating said alarm whenever said sensor detects air pressure outside normal operating conditions.

33. A method as in claim 31 wherein said sensor monitors high and low pressure.

34. A method as in claim 33 further comprising the step of activating said alarm whenever said sensor detects air pressure which rises above or falls below normal operating conditions.

35. A method as in claim 34 wherein said alarm emits both an audible and a visual warning when activated.

36. A method as in claim 34 further comprising the step of testing said alarm.

37. A method as in claim 35 further comprising the step of muting the audible portion of the alarm warning.
